(19) United States
(12) Patent Application Publication
(10) Pub. No.: US 2022/0397805 A1
(43) Pub. Date: Dec. 15, 2022

(54) CAMERA MODULE

(71) Applicant: SAMSUNG ELECTRO-MECHANICS CO., LTD., Suwon-si (KR)

(72) Inventors: Sang Jin LEE, Suwon-si (KR); Ga Yeon JU, Suwon-si (KR)

(73) Assignee: SAMSUNG ELECTRO-MECHANICS CO., LTD., Suwon-si (KR)

(21) Appl. No.: 17/700,759

(22) Filed: Mar. 22, 2022

(30) Foreign Application Priority Data
Jun. 11, 2021 (KR) 10-2021-0075974

(51) Int. Cl. G03B 13/36; H01F 7/08; H01F 7/126

(52) U.S. Cl. CPC G03B 13/36; H01F 7/081; H01F 7/126; G02B 27/646

(57) ABSTRACT

A camera module includes: a housing; a support frame at least partially disposed the housing; a first lens holder, which includes a lens and which disposed in the housing to be moveable along a first direction parallel to an optical axis direction; and a buffer member disposed on the support frame.

### CROSS-REFERENCE TO RELATED APPLICATION(S)

This application claims the benefit under 35 USC 119(a) of Korean Patent Application No. 10-2021-0075974 filed on Jun. 11, 2021 in the Korean Intellectual Property Office, the entire disclosure of which is incorporated herein by reference for all purposes.

### BACKGROUND

### 1. Field

The following description relates to technology related to a camera module, and more particularly, to technology related to a camera module including an optical-path change member changing an optical path.

### 2. Description of Background

A camera module has been basically used in a portable electronic device such as a tablet personal computer (PC) or a laptop computer as well as a smartphone, and the camera module for a mobile terminal may further have an auto-focus (AF) function, an optical image stabilization (OIS) function, a zoom function and the like.

A lens barrel is required to be moved in an optical axis direction to implement the auto-focus (AF) function and the zoom function. Here, the camera module may include a stopper that limits a range in the lens barrel is moved in the optical axis direction. Noise may occur when the lens barrel hits the stopper. To mitigate the noise, a buffer member made of urethane material may be interposed between the lens barrel and the stopper.

In the prior art, the stopper may be made of a separate member and then fitted into a housing of the camera module. However, a size of the stopper is very small in the camera module of the mobile device, and it may thus be a complicate process in which the stopper is assembled to the camera module.

### SUMMARY

This Summary is provided to introduce a selection of concepts in simplified form that are further described below in the Detailed Description. This Summary is not intended to identify key features or essential features of the claimed subject matter, nor is it intended to be used as an aid in determining the scope of the claimed subject matter.

In one general aspect, a camera module includes: a housing; a support frame at least partially disposed in the housing; a first lens holder, which includes a lens and is disposed in the housing to be moveable along a first direction parallel to an optical axis direction; and a buffer member disposed on the support frame.

The buffer member may be configured to be in contact with the first lens holder as the first lens holder moves along the first direction.

The buffer member may be spaced apart from a surface of the housing.

The support frame may be exposed to air and may include an exposed portion bordering the surface of the housing, and the buffer member may be disposed in the exposed portion.

The camera module may include a reinforcing member disposed in a bottom portion of the housing, and the support frame may be integral with the reinforcing member.

The reinforcing member may be plate shaped, and the support frame may include a bent portion extending from the reinforcing member.

The camera module may include: a magnet disposed on the first lens holder; and a yoke disposed in the housing opposite to the magnet, and the support frame may be integral with the yoke.

The buffer member may include urethane.

The camera module may include a second lens holder moveable along the first direction, and the buffer member may be configured to be in contact with the second lens holder as the second lens holder moves along the first direction.

The camera module may include an optical-path change member disposed in the housing, and the optical-path change member may be configured to direct light incident in the housing along the first direction.

In another general aspect, a camera module may include: a housing; a first lens holder, which includes a lens and is disposed in the housing to be moveable along a first direction parallel to an optical axis direction; a first support frame at least partially disposed in the first lens holder; and a first buffer member disposed on the first support frame.

The first buffer member may be configured to be in contact with the housing or a member fixed to the housing as the first lens holder moves along in the first direction.

The camera module may include: a second lens holder configured to move along the first direction; and a second buffer member disposed on a second support frame that is at least partially disposed in the second lens holder.

The second buffer member may be configured to be in contact with the housing or a member fixed to the housing as the second lens holder moves along the first direction.

The camera module may include an optical-path change member disposed in the housing, and the optical-path change member may be configured to direct light incident in the housing along the first direction.

Other features and aspects will be apparent from the following detailed description, the drawings, and the claims.

### BRIEF DESCRIPTION OF DRAWINGS

FIG. 1 is a perspective view of an electronic device including a camera module according to an example.

FIG. 2 is a perspective view of the camera module according to an example.

FIG. 3 is an internal perspective view of the camera module according to an example.

FIG. 4 is an exploded perspective view of the camera module according to an example.

FIG. 5 is a view showing that a lens module is driven to perform an auto-focus (AF) function in an example.

FIG. 6 shows a support frame inserted into a housing in an example.

FIG. 7A shows a buffer member formed integrally with the housing in an example.

FIG. 7B shows the buffer member attached to the support frame exposed to a surface of the housing in an example.

FIG. 8 shows buffer members respectively formed integrally with lens holders in an example.

FIG. 9 is a view showing that the auto-focus (AF) function is performed when the buffer members are respectively positioned in the lens holders in an example.

Throughout the drawings and the detailed description, the same reference numerals refer to the same elements. The drawings may not be to scale, and the relative size, proportions, and depictions of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent to one of ordinary skill in the art. The sequences of operations described herein are merely examples, and are not limited to those set forth herein, but may be changed as will be apparent to one of ordinary skill in the art, with the exception of operations necessarily occurring in a certain order. Also, descriptions of functions and constructions that would be well known to one of ordinary skill in the art may be omitted for increased clarity and conciseness.

The features described herein may be embodied in different forms, and are not to be construed as being limited to the examples described herein. Rather, the examples described herein have been provided so that this disclosure will be thorough and complete, and will fully convey the scope of the disclosure to one of ordinary skill in the art.

Herein, it is noted that use of the term “may” with respect to an example or embodiment, e.g., as to what an example or embodiment may include or implement, means that at least one example or embodiment exists in which such a feature is included or implemented while all examples and embodiments are not limited thereto.

Throughout the specification, when an element, such as a layer, region, or substrate, is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween.

As used herein, the term “and/or” includes any one and any combination of any two or more of the associated listed items.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Spatially relative terms such as “above,” “upper,” “below,” and “lower” may be used herein for ease of description to describe one element's relationship to another element as illustrated in the figures. Such spatially relative terms are intended to encompass different orientations of the device in use or operation in addition to the orientation depicted in the figures. For example, if the device in the figures is turned over, an element described as being “above” or “upper” relative to another element will then be “below” or “lower” relative to the other element. Thus, the term “above” encompasses both the above and below orientations depending on the spatial orientation of the device. The device may also be oriented in other ways (for example, rotated 90 degrees or at other orientations), and the spatially relative terms used herein are to be interpreted accordingly.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

Due to manufacturing techniques and/or tolerances, variations of the shapes illustrated in the drawings may occur. Thus, the examples described herein are not limited to the specific shapes illustrated in the drawings, but include changes in shape that occur during manufacturing.

The features of the examples described herein may be combined in various ways as will be apparent after an understanding of the disclosure of this application. Further, although the examples described herein have a variety of configurations, other configurations are possible as will be apparent after an understanding of the disclosure of this application.

The drawings may not be to scale, and the relative sizes, proportions, and depiction of elements in the drawings may be exaggerated for clarity, illustration, and convenience.

Hereinafter, examples will be described in detail with reference to the accompanying drawings.

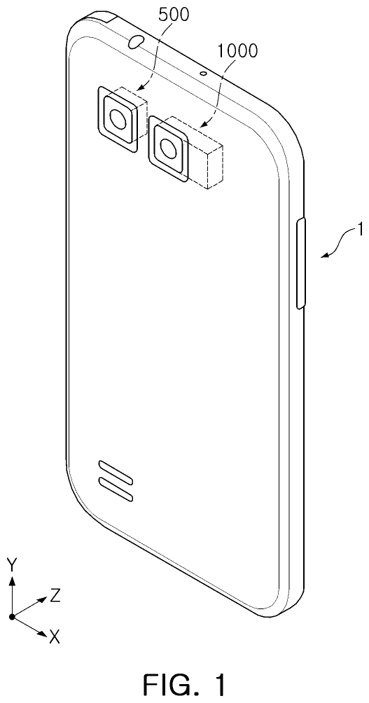

FIG. 1 is a perspective view of an electronic device including a camera module 1000 according to an example.

FIG. 1 is the perspective view of a portable electronic device 1 according to an example.

Referring to FIG. 1, the portable electronic device 1 may be a portable electronic device such as a mobile communications terminal, a smartphone or a tablet personal computer (PC) in which a plurality of camera modules 500 and 1000 are mounted.

In this example, the plurality of camera modules 500 and 1000 may be mounted in the portable electronic device 1. The plurality of camera modules 500 and 1000 may be arranged to be aligned left and right as shown, or may be arranged to be aligned vertically, although not shown.

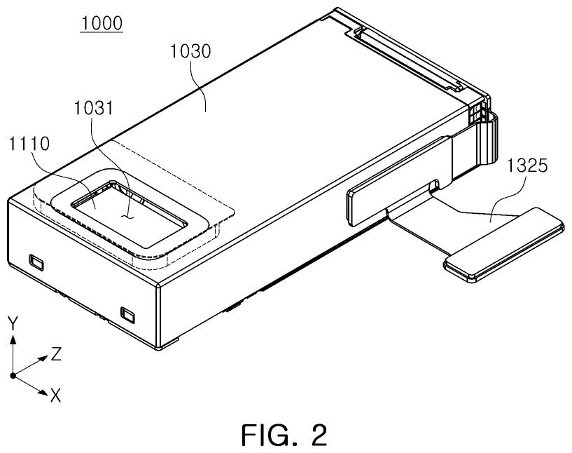

At least one camera module 1000 among the plurality of camera modules 500 and 1000 may be the camera module 1000 according to an example described below with reference to a plurality of drawings including FIG. 2. That is, when the portable electronic device 1 has the dual camera modules 500 and 1000, at least one of the two camera modules 500 and 1000 may be the camera module 1000 according to an example.

The camera module 1000 and the portable electronic device 1 may have a simple structure and reduce the size while implementing functions such as auto-focus (AF) function, a zoom function, an optical image stabilization (01S) function and the like. It is also possible to significantly reduce power consumption.

The camera module 1000 may include a plurality of lenses, in which an optical axis (Z axis) of each of the lenses may be directed toward a direction perpendicular to a thickness direction (Y-axis direction, i.e. direction from a front surface of the portable electronic device to its rear surface or the opposite direction) of the portable electronic device 1.

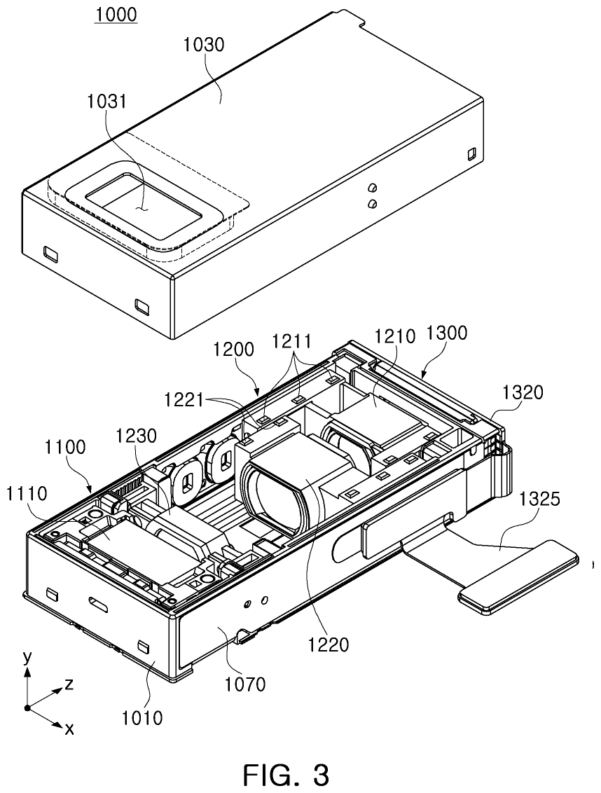

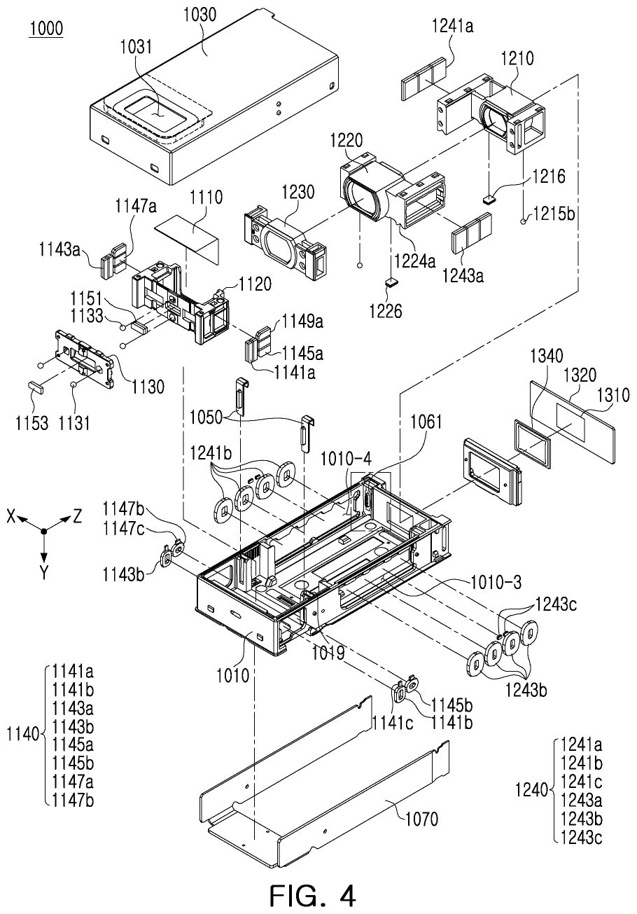

FIG. 2 is a perspective view of the camera module 1000; FIG. 3 is an internal perspective view of the camera module 1000; and FIG. 4 is a perspective view of the camera module 1000.

Referring to FIGS. 2 and 3, the camera module 1000 may include a reflection module 1100, a lens module 1200 and an image sensor module 1300, positioned in a housing 1010.

The reflection module may be configured to change a propagation direction of light. For example, the propagation direction of light incident through an opening 1031 of a cover 1030 covering the camera module 1000 above the camera module 1000 may be changed through the reflection module 1100 for the incident light to be directed toward the lens module 1200. To this end, the reflection module 1100 may include an optical-path change member 1110 that changes a path of light (e.g., by reflecting the light). The optical-path change member 1110 may be implemented in any of various forms, such as a mirror, a prism or a beam splitter.

For example, a path of light incident to the camera module 1000 in the thickness direction (Y-axis direction) of the camera module 1000 may be changed by the reflection module 1100 to approximately coincide with an optical axis (Z-axis) direction. The light whose path is changed may then be incident on the lens module 1200.

The lens module 1200 may include the plurality of lenses through which the light whose propagation direction is changed by the reflection module 1100 passes. The lens module 1200 may include a plurality of lens holders 1210, 1220 and 1230. This example shows that the plurality of lens holders is exemplified as three lens holders, and may be more than one lens holder. In an example, the plurality of lenses may each be accommodated in a lens barrel, and the lens barrel may be fixedly coupled to the lens holders 1210, 1220, and 1230.

The auto-focus (AF) and zoom functions may be implemented as at least one of the plurality of lens holders 1210, 1220 and 1230 is moved in the optical axis (Z-axis) direction.

In this example, all the three lens holders 1210, 1220 and 1230 may be moved in the optical axis direction, or any one of the three lens holders, e.g., the lens holder 1230, may be fixed not to be moved in the optical axis direction, and the auto-focus (AF) and zooming functions may be implemented by moving the lens holders 1210 and 1220.

The image sensor module 1300 may include an image sensor 1310 converting the light that passed through the plurality of lenses into an electrical signal and a printed circuit board 1320 on which the image sensor 1310 is mounted. The image sensor module 1300 may include an optical filter 1340 filtering the light that passes through the lens module 1200 and is then incident thereto. The optical filter 1340 may be an infrared cut-off filter.

In an inner space of the housing 1010, the reflection module 1100 may be positioned in front of the lens module 1200, and the image sensor module 1300 may be positioned in rear of the lens module 1200, based on the lens module 1200.

The inner space of the housing 1010 may include the circuit board 1320 and a main substrate 1070, —which may supply power or transmit and receive a control signal to a first driver 1140 of the reflection module 1100, a second driver 1240 of the lens module 1200, and the image sensor 1310 of the image sensor module 1300; and a terminal 1325 connected to each of the circuit board 1320 and the main substrate 1070.

The reflection module 1100 may include a rotation holder 1120. The housing 1010 and the rotation holder 1120 opposite thereto may respectively have a first magnetic member 1151 and a second magnetic member 1153 on surfaces opposite to each other, and the rotation holder 1120 may be supported (or adhered) to the housing 1010 by an attractive force between the first magnetic member 1151 and the second magnetic member 1153.

The first magnetic member 1151 and the second magnetic member 1153 may respectively be a pulling yoke and a pulling magnet. For example, the first magnetic member 1151 and the second magnetic member 1153 may optionally be the pulling yoke and the pulling magnet, or both the first magnetic member 1151 and the second magnetic member 1153 may be the pulling magnets.

A first ball member 1131, a rotating plate 1130 and a second ball member 1133 may be positioned between an inner wall surface of the housing 1010 and the rotation holder 1120.

In an example, a buffer member 1050 may be positioned between the rotation holder 1120 and the housing 1010. The buffer member 1050 may serve as a stopper that adjusts a movement of the rotation holder 1120 or a buffer member that absorbs an impact thereto.

The reflection module 1100 may change the path of the light incident thereto through the opening 1031. When an image or a video is captured, the image may be blurred or the video may be unstable due to a user's hand trembling or the like. In this case, the reflection module 1100 may stabilize the blurred or unstable image by moving the rotation holder 1120 on which the optical-path change member 1110 is mounted.

The reflection module 1100 may include the first driver 1140 that moves the rotation holder 1120. The rotation holder 1120 on which the optical-path change member 1110 is mounted may be movably accommodated in the inner space of the housing 1010. For example, the rotation holder 1120 may be accommodated in the housing 1010 to be rotated about a first axis and a second axis. The first axis and the second axis may indicate an axis perpendicular to the optical axis (Z axis), and the first axis and the second axis may be axes perpendicular to each other. For example, the first axis may be parallel to an X axis shown in the drawings, and the second axis may be parallel to the Y axis shown in the drawings.

The first driver 1140 may generate a driving force by which the rotation holder 1120 is rotated about the two axes. For example, the first driver 1140 may include a plurality of magnets 1141a, 1143a, 1145a and 1147a, and a plurality of coils 1141b, 1143b, 1145b and 1147b arranged to face the plurality of magnets 1141a, 1143a, 1145a and 1147a.

The example shows that the coils for the reflection module 1100 and coils for the lens module 1200 are arranged on the main substrate 1070 in one whole piece to be all mounted on the main substrate 1070. However, the coils for the reflection module 1100 and the coils for the lens module 1200 may be separately arranged on two or more substrates to respectively be mounted on the main substrate 1070.

In an example, the camera module 1000 may have two of the lens holders—lens holder 1210 and lens holder 1220—positioned in the inner space of the housing 1010 to be moved in the optical axis (Z-axis) direction.

The lens holders 1210 and 1220 may be configured to be approximately moved in the optical axis (Z-axis) direction to implement the auto-focus (AF) and zoom functions. The lens holders 1210 and 1220 may be moved relative to the housing 1010 by the second driver 1240 in the optical axis (Z-axis) direction. The second driver 1240 may individually move the lens holder 1220 in the optical axis (Z-axis) direction to implement the auto-focus (AF) and zoom functions.

For example, the second driver 1240 may include a plurality of magnets 1241a and 1243a and the plurality of coils 1241b and 1243b disposed to face the plurality of magnets 1241a and 1243a.

For example, each of the magnets 1241a and 1243a may be magnetized to have two or more poles to sequentially have at least N and S poles in the optical axis direction, and each of the coils 1241b and 1243b may include at least two or more coils.

When power is applied to the plurality of coils 1241b and 1243b, the lens holder 1220 on which the plurality of magnets 1241a and 1243a are separately mounted, may be individually moved in the optical axis (Z-axis) direction by electromagnetic interaction between the plurality of magnets 1241a and 1243a and the plurality of coils 1241b and 1243b. Accordingly, the zoom function or the auto-focus function may be implemented.

The plurality of magnets 1241a and 1243a may be separately mounted on the lens holders 1210 and 1220. For example, the magnet 1241a may be mounted on a side surface of the lens holder 1210, and the magnet 1243a may be mounted on a side surface of the lens holder 1220.

The plurality of coils 1241b and 1243b may respectively be mounted on the housing 1010 to face the plurality of magnets 1241a and 1243a.

The plurality of magnets 1241a and 1243a may be separately positioned on the both side surfaces of the lens holder 1220, respectively, and the plurality of coils 1241b and 1243b may also be separately positioned on both sidewalls of the housing 1010 to oppose each other.

For example, the plurality of coils 1241b and 1243b may be mounted on the main substrate 1070, and the main substrate 1070 may be attached to an outer surface of the housing 1010 in such a manner that the plurality of coils 1241b and 1243b are exposed to the inside of the housing 1010 through through-holes 1010-3 and 1010-4.

This example uses a closed-loop control method that detects and feeds back positions of the lens holders 1210 and 1220 when the lens holders 1210 and 1220 are moved. Therefore, position sensors 1241c and 1243c may be required in order to perform a closed loop control. The position sensors 1241c and 1243c may each be a hall sensor, a tunneling magneto resistance (TMR) angle sensor, a general TMR sensor, etc.

The position sensors 1241c and 1243c may be positioned inside or outside the coils 1241b and 1243b, and the position sensors 1241c and 1243c may also be mounted on the main substrate 1070 on which the coils 1241b and 1243b are mounted. The plurality of position sensors 1241c and 1243c may respectively be spaced apart from each other in the optical axis direction considering that the second lens holder 1220 has a very long movement distance.

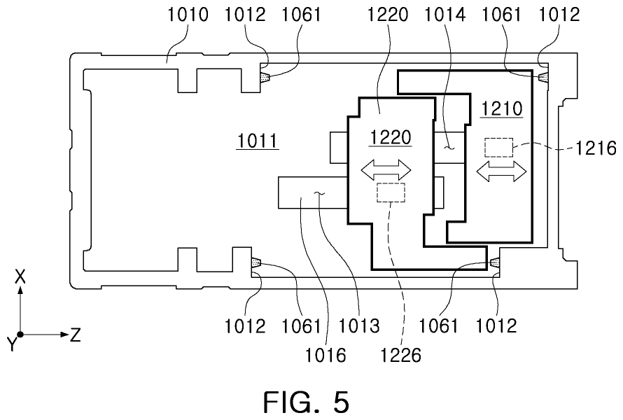

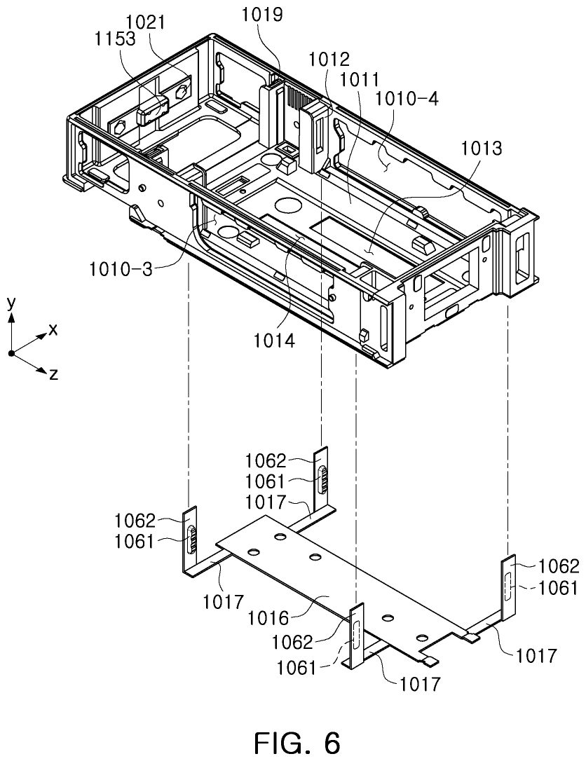

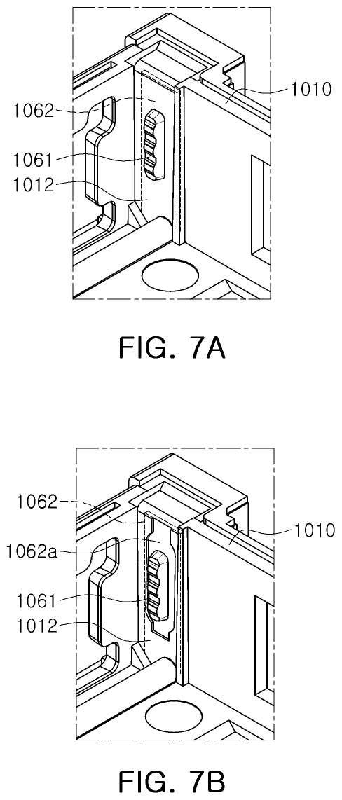

FIG. 5 is a view showing that the lens module 1200 is driven to perform an auto-focus (AF) function in an example; FIG. 6 shows a support frame 1062 inserted into the housing 1010 in an example; FIG. 7a shows a buffer member 1061 formed integrally with the housing 1010 in an example; and FIG. 7B shows the buffer member 1061 attached to the support frame 1062 exposed to a surface of the housing 1010 in an example.

Referring to FIG. 5, the lens holders 1210 and 1220 may be configured to be moved relative to the housing 1010 in the optical axis direction.

When reaching the upper limit or lower limit of its movement range, each of the lens holders 1210 and 1220 may hit the buffer member 1061 positioned on one side of its movement direction. For example, when the lens holders 1210 and 1220 are moved in a −Z direction, each front surface of the lens holders 1210 and 1220 may hit the buffer member 1061 each positioned in front of the lens holders 1210 and 1220. The buffer member 1061 may include an elastic material such as urethane, rubber, silicone or sponge, and may reduce noise or impact, which occurs when the lens holder 1210 or 1220 collides with the buffer member 1061.

The front of the lens holder 1210 or 1220 may indicate a direction in which the lens holder 1210 or 1220 is moved away from the image sensor 1310 (i.e., −Z direction), and the rear of the lens holder 1210 or 1220 may indicate a direction in which the lens holder 1210 or 1220 is moved closer to the image sensor 1310 (i.e., +Z direction).

The buffer member 1061 may be formed integrally with the housing 1010. That is, the housing 1010 itself may be made to include the buffer member 1061 without a separate manufacturing process for assembling the buffer member 1061 to the housing 1010. For example, the housing 1010 may be made by pouring liquid plastic into a mold and hardening the plastic. Here, the plastic may be introduced into the mold in a state in which the buffer member 1061 is positioned inside the mold, and the buffer member 1061 may thus be firmly coupled to the housing 1010 as the plastic hardens.

The buffer member 1061 may be attached to the housing 1010 by the support frame 1062. For example, the buffer member 1061 may be attached to the support frame 1062, and the support frame 1062 may then be positioned inside the mold for molding the housing 1010. The liquid plastic may at least partially wrap a surface of the support frame 1062, and the support frame 1062 may thus be firmly coupled to the housing 1010 as the plastic hardens.

Referring to FIG. 7A, the buffer member 1061 may protrude from an inner wall 1012 of the housing 1010 in the optical axis direction. Referring to FIG. 7B, the buffer member 1061 may be spaced apart from the surface of the housing 1010. The buffer member 1061 may be melted or deformed when coming into contact with the liquid plastic. For example, the buffer member 1061 may include urethane, and the urethane has a relatively low melting point. In this case, the buffer member 1061 may be melted if coming into direct contact with the liquid plastic. To prevent or minimize damage to the buffer member 1061, a process of molding the housing 1010 is required to be performed for the plastic not to or minimally touch the buffer member 1061. In the completed housing 1010, the buffer member 1061 may thus be spaced apart from the surface of the housing 1010.

Referring to FIG. 7B, a portion of the support frame 1062 may be exposed to air, and the buffer member 1061 may be positioned on an exposed portion 1062a of the support frame 1062. In an example, the exposed portion 1062a of the support frame 1062 may be exposed to the air, and an edge of the exposed portion 1062a may be in contact with the surface of the housing 1010. The buffer member 1061 may be positioned inside the edge of the exposed portion 1062a, and the buffer member 1061 may thus be spaced apart from the surface of the housing 1010.

Referring to FIG. 6, a reinforcing member 1016 may be included in the housing 1010. In order to make the camera module smaller and thinner, the thickness of the housing 1010 is formed to be relatively thin, and the camera module may thus have a relatively weak rigidity. In particular, a bottom portion 1011 of the housing 1010 has a shape of a thin plate and may thus be structurally weaker than other portions. In an example, the reinforcing member 1016 may be inserted into the bottom portion 1011 of the housing 1010 to reinforce the rigidity of the housing 1010. In an example, the reinforcing member 1016 may have a shape of a plate inserted into the bottom portion 1011 of the housing 1010.

The reinforcing member 1016 and the support frame 1062 may be integrally formed with each other. For example, the support frame 1062 may be formed as a portion bent and extending from the reinforcing member 1016. For example, a branch 1017 may extend from an edge of the reinforcing member 1016, and the portion bent and extending from an end of the branch 1017 may function as the support frame 1062. Referring to FIG. 6, the reinforcing member 1016 may include the four branches 1017 extending from the edge of the reinforcing member 1016 in the X direction. The reinforcing member 1016 may include the support frame 1062 extending at the ends of the four branches 1017 in a +Y direction.

The housing 1010 may be made in such a manner that the support frame 1062 and the reinforcing member 1016 are inserted into the mold, and the plastic is then introduced into the mold and hardens. The buffer member 1061 may already be attached to the support frame 1062 that goes into the mold. FIG. 6 shows that the support frame 1062 and the reinforcing member 1016 are made as a single member, which is only an example. In another example, the support frame 1062 and the reinforcing member 1016 may be made separately from each other.

The lens holders 1210 and 1220 may be moved smoothly on the bottom portion 1011 of the housing 1010 by a rolling member such as a ball member in the optical axis direction. For example, a guide groove extending in the optical axis direction may be formed in the bottom portion 1011 of the housing 1010 between the lens holders 1210 and 1220, and the guide groove and the ball member moved along the guide groove may thus guide the movement of the lens holders 1210 and 1220 in the optical axis direction. The lens holders 1210 and 1220 may be moved in the optical axis direction for performing the zoom function or the auto-focus function, and the ball guide and ball member may thus be required to be in constant contact with each other in order for the lens holders 1210 and 1220 to be strictly constrained to be moved only in the optical axis direction. The contact between the ball guide and the ball member are required to be maintained even when the camera (or the electronic device in which the camera module is mounted) is shaken or subjected to the impact. To this end, the lens holders 1210 and 1220 may be required to be constantly pulled towards the bottom portion 1011 during their movements.

In an example, the camera module 1000 may include a pulling member pulling the lens holders 1210 and 1220 into the bottom portion 1011. The pulling member may include magnetic members respectively positioned on the lens holders 1210 and 1220 and the bottom portion 1011, and opposite to each other. For example, magnets 1216 and 1226 may be positioned under the lens holders 1210 and 1220 and a yoke opposite to each magnet may be positioned on the bottom portion 1011 of the housing 1010.

A portion of the reinforcing member 1016 may function as a yoke to provide a pulling force to the lens holders 1210 and 1220. For example, the reinforcing member 1016 may include a material generating a magnetic attraction between the magnets 1216 and 1226 and the reinforcing member 1016. That is, there may be the magnetic attraction between the reinforcing member 1016 and the magnets 1216 and 1226 attached to lower surfaces of the lens holders 1210 and 1220, which may allow the lens holders 1210 and 1220 to be moved smoothly in the optical axis direction.

A portion of the reinforcing member 1016 may be exposed to the air. Referring to FIG. 6, the bottom portion 1011 of the housing 1010 may include openings 1013 and 1014 and the portion of the reinforcing member 1016 may be exposed to the air through the openings 1013 and 1014. The reinforcing member 1016 and the magnets 1216 and 1226 may thus have a strong magnetic attraction therebetween. The magnets 1216 and 1226 each having a relatively small size may provide the pulling force required to perform the AF function, which may contribute to a smaller weight of each of the lens holders 1210 and 1220 and performance of the AF function.

The openings 1013 and 1014 may each have a shape corresponding to each movement path of the magnets 1216 and 1226 attached to the lens holders 1210 and 1220. In an example, the openings 1013 and 1014 may respectively extend along the movement paths of the magnets 1216 and 1226. For example, the housing 1010 may include the first opening 1013 corresponding to the first pulling magnet 1216 attached to the bottom of the lens holder 1210, and the second opening 1014 corresponding to the second pulling magnet 1226 attached to the bottom of the lens holder 1220.

In this example, the first opening 1013 and the second opening 1014 are distinguished from each other, which is only an example, and in another example, the first opening 1013 and the second opening 1014 may be formed into one opening.

The camera module 1000 according to an example may include: the housing 1010; the lens holder 1210 in which a lens is included and which is positioned in the housing 1010 to be moved in a first direction parallel to the optical axis direction; and the buffer member 1061 formed integrally with the housing 1010 and positioned to be in contact with the lens holder 1210 as the lens holder 1210 is moved in the first direction.

The camera module 1000 may further include the support frame 1062 at least partially inserted into the housing 1010, in which the buffer member 1061 may be attached to the support frame 1062.

The buffer member 1061 may be spaced apart from the surface of the housing 1010. The support frame 1062 may be exposed to the air and include the exposed portion 1062a bordering the surface of the housing 1010, and the buffer member 1061 may be positioned in the exposed portion 1062a.

The camera module 1000 may further include the reinforcing member 1016 inserted into the bottom portion 1011 of the housing 1010, in which the support frame 1062 may be formed integrally with the reinforcing member 1016. The reinforcing member 1016 may have the shape of a plate, and the support frame 1062 may include the portion bent and extending from the reinforcing member 1016.

The camera module 1000 may further include: the magnet attached to the lens holder 1210; and the yoke inserted into the housing 1010 and positioned opposite to the magnet, in which the support frame 1062 may be formed integrally with the yoke.

The buffer member 1061 may include urethane.

The camera module 1000 may further include the lens holder 1220 moved in the first direction, in which the buffer member 1061 may be positioned to be in contact with the lens holder 1220 as the lens holder 1220 is moved in the first direction.

The camera module 1000 may further include the optical-path change member 1110 positioned in the housing 1010, and configured to convert the light incident in the housing 1010, in the first direction.

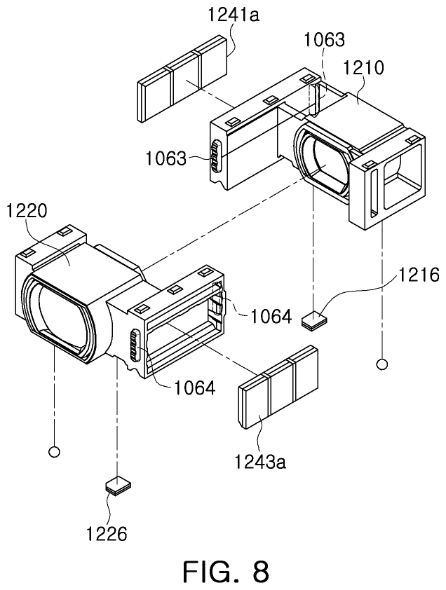

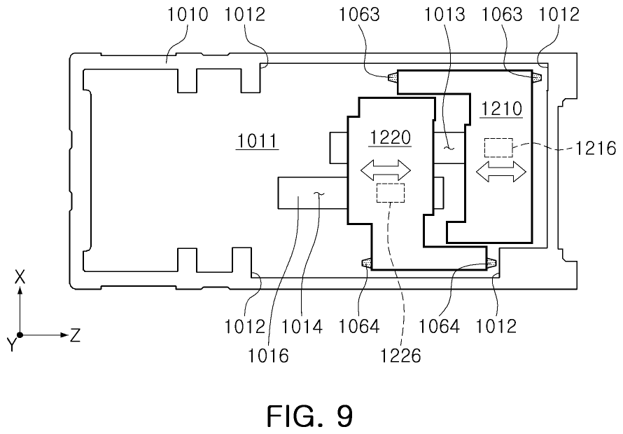

FIG. 8 shows buffer members 1063 and 1064 respectively formed integrally with the lens holders 1210 and 1220 in an example; and FIG. 9 is a view showing that the auto-focus (AF) function is performed when the buffer members 1063 and 1064 are respectively positioned in the lens holders 1210 and 1220 in an example.

In an exemplary embodiment, the buffer members 1063 and 1064 may respectively be positioned on the lens holders 1210 and 1220. Referring to FIG. 9, when the lens holders 1210 and 1220 are moved in the optical axis direction, the buffer members 1063 and 1064 positioned on the front or rear of the lens holders 1210 and 1220 may be in contact with the inner wall 1012 of the housing 1010.

In an example, the buffer members 1063 and 1064 may respectively be formed integrally with the lens holders 1210 and 1220. For example, the buffer members 1063 and 1064 may be directly inserted into the lens holders 1210 and 1220, respectively. That is, the lens holders 1210 and 1220 themselves may respectively be formed to include the buffer members 1063 and 1064 without a separate manufacturing process for assembling the buffer members 1063 and 1064 into the lens holders 1210 and 1220. For example, the lens holders 1210 and 1220 may be made by pouring liquid plastic into a mold and hardening the plastic. The plastic may be introduced into the mold in a state in which the buffer members 1063 and 1064 are positioned inside the mold, and the buffer members 1063 and 1064 may thus be firmly coupled to the lens holders 1210 and 1220 as the plastic hardens.

The buffer members 1063 and 1064 may respectively be attached to the lens holders 1210 and 1220 by a support frame. For example, the buffer members 1063 and 1064 may be attached to the support frame, and the support frame may then be positioned inside the mold for molding the housing 1010. The liquid plastic may at least partially wrap the surface of the support frame, and the support frame may thus be firmly coupled to the lens holders 1210 and 1220 as the plastic hardens. The support frame may have a shape similar to that of the support frame 1062 shown in FIGS. 6 through 7B.

The camera module 1000 according to another example may include: the housing 1010; the lens holder 1210 in which a lens is included and which is positioned in the housing 1010 to be moved in the first direction parallel to the optical axis direction; and the buffer member 1063 formed integrally with the lens holder 1210 and positioned to be in contact with the housing 1010 or a member fixed to the housing 1010 as the lens holder 1210 is moved in the first direction.

The camera module 1000 may further include the support frame at least partially inserted into the lens holder 1210 and 1220, in which the buffer member 1063 may be attached to the support frame.

The camera module 1000 may further include: a lens holder 1220 moved in the first direction; and the buffer member 1064 formed integrally with the lens holder 1220 and positioned to be in contact with the housing 1010 or the member fixed to the housing 1010 as the lens holder 1220 is moved in the first direction.

The camera module 1000 may further include the optical-path change member 1110 positioned in the housing 1010, and configured to convert the light incident in the housing 1010, in the first direction.

As set forth above, according to the various examples, it is possible to provide the buffer member which may mitigate the noise occurring when the lens module is moved in the optical axis direction. The buffer member may be mounted in the camera module more easily, which may make the process of manufacturing the camera module more efficient.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed to have a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A camera module comprising:
a housing;
a support frame at least partially disposed in the housing;
a first lens holder, which comprises a lens and is disposed in the housing to be moveable along a first direction parallel to an optical axis direction; and
a buffer member formed on the support frame.

2. The camera module of claim 1, wherein the buffer member is configured to be in contact with the first lens holder as the first lens holder moves along the first direction.

3. The camera module of claim 2, wherein the buffer member is spaced apart from a surface of the housing.

4. The camera module of claim 3, wherein the support frame is exposed to air and comprises an exposed portion bordering the surface of the housing, and the buffer member is disposed in the exposed portion.

5. The camera module of claim 2, further comprising a reinforcing member disposed in a bottom portion of the housing,
wherein the support frame is integral with the reinforcing member.

6. The camera module of claim 5, wherein the reinforcing member is plate shaped, and the support frame comprises a bent portion extending from the reinforcing member.

7. The camera module of claim 2, further comprising:
a magnet disposed on the first lens holder; and
a yoke disposed in the housing opposite to the magnet,
wherein the support frame is integral with the yoke.

8. The camera module of claim 1, wherein the buffer member comprises urethane.

9. The camera module of claim 1, further comprising a second lens holder moveable along the first direction,
wherein the buffer member is configured to be in contact with the second lens holder as the second lens holder moves along the first direction.

10. The camera module of claim 1, further comprising an optical-path change member disposed in the housing, and configured to direct light incident in the housing along the first direction.

11. A camera module comprising:
a housing;
a first lens holder, which comprises a lens and is disposed in the housing to be moveable along a first direction parallel to an optical axis direction;
a first support frame at least partially disposed the first lens holder; and
a first buffer member disposed on the first support frame.

12. The camera module of claim 11, wherein the first buffer member is configured to be in contact with the housing or a member fixed to the housing as the first lens holder moves along in the first direction.

13. The camera module of claim 11, further comprising:
a second lens holder configured to move along the first direction; and
a second buffer member disposed on a second support frame that is at least partially disposed in the second lens holder.

14. The camera module of claim 13, wherein the second buffer member is configured to be in contact with the housing or a member fixed to the housing as the second lens holder moves along the first direction.

15. The camera module of claim 11, further comprising an optical-path change member disposed in the housing, and configured to direct light incident in the housing along the first direction.
